(19) United States
(12) Patent Application Publication
(10) Pub. No.: US 2016/0232800 A1
(43) Pub. Date: Aug. 11, 2016

(54) INTEGRATED SOCIAL CLASSROOM AND PERFORMANCE SCORING

(71) Applicant: Apollo Education Group, Inc., Phoenix, AZ (US)

(72) Inventors: Ginny Heenan, Belmont, CA (US); Pankaj Mishra, Tempe, AZ (US); Nitin Mulimani, Tempe, AZ (US); Brig Lamoreaux, Gilbert, AZ (US)

(21) Appl. No.: 14/619,321

(22) Filed: Feb. 11, 2015

(51) Int. Cl. G09B 7/00; H04L 29/08; H04L 12/58; G09B 5/02

(52) U.S. Cl. CPC G09B 7/00; G09B 5/02; H04L 67/22; H04L 51/046

(57) ABSTRACT

Integrated social classroom and performance scoring is provided. One or more content items submitted by a member of an educational network are displayed to one or more other members of the educational network. A set of content item scores is determined that includes a content item score for each of at least a subset of the one or more content items submitted by the member. A member contribution metric is determined for the member based on the set of content item scores. A member performance metric is determined for the member based on at least one performance assessment of the member with respect to one or more courses. An integrated member score is determined for the member based on the member contribution metric and the member performance metric.

### FIELD

Embodiments described herein relate generally to computer systems, and, more specifically, to techniques for integrated social classroom and performance scoring.

### BACKGROUND

In a live classroom setting, students have in-person access to their classmates. Such social interaction in a classroom setting increases engagement and participation, and may improve performance of students who take advantage of such collaboration. When a course is offered online, the user may be provided electronic peer access to a group of classmates enrolled in the same course offering. Electronic peer access enhances the online experience of a student by simulating the same type of interactions that occur in a physical classroom of individuals enrolled in the same course offering. For example, electronic peer access may involve use of a message board that is dedicated to the course offering. Such a message board may be available to students and/or faculty associated with the particular course offering.

Typically, user engagement in electronic peer access is low despite the fact that user engagement in electronic peer access is correlated with better performance, course completion and program completion. When user engagement is high, students can quickly and easily access a greater network of peers and faculty members and get more relevant answers more quickly. Furthermore, user engagement is correlated with skills that extend beyond the virtual classroom, such as career skills. However, the amount and quality of participation in electronic peer access is not reflected in grades or other typical assessments of students and/or faculty.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram depicting an example system architecture;

FIG. 2 is a flow diagram that depicts an embodiment of a process for scoring a content item;

FIG. 3 is a flow diagram that depicts an embodiment of a process for generating an integrated member score;

FIG. 4 depicts a computer system upon which one or more embodiments may be implemented.

### DETAILED DESCRIPTION

In the following description, for the purposes of explanation, numerous specific details are set forth in order to provide a thorough understanding of the embodiments. It will be apparent, however, that embodiments may be practiced without these specific details. In other instances, well-known structures and devices are shown in block diagram form in order to avoid unnecessarily obscuring embodiments.

### General Overview

Techniques are described herein for integrated social classroom and performance scoring of members of an educational network. An integrated member score is generated for a member based on the member's educational performance as well as the member's social participation. The integrated member score is based on a contribution component and a performance component.

The contribution component is based on contributions of the member to the social classroom experience, such as content items submitted by the member. Content items submitted by a contributing member are made available to other members of the educational network. Traditional grading and assessment schemes often do not reflect such contributions, even though these contributions enhance the educational experience for the contributing member and/or members who view the contributing member's content items. Furthermore, these contributions may reflect desirable traits in the member that are beneficial to measure. In one embodiment, each content item is evaluated by determining a content item score. The content item scores for content items generated by a particular member are used to determine a member contribution metric for the member.

The performance component is based on at least one performance assessment of the member. The performance component is quantified by determining a member performance metric based on at least one assessment of the member. When the member is a student that is currently registered in a current course, the performance assessment may assess the performance of the student with respect to the current course. When the member is a faculty member of a current course, the performance assessment may assess the performance of students of the faculty member in the current course. Furthermore, performance assessments with respect to one or more prior courses may be considered.

An integrated member score is determined based on the member contribution metric and the member performance metric. The framework for integrated member scoring allows for the consideration of not only the user's participation in a virtual classroom environment, but also the quality of content submitted by the user. Furthermore, the framework allows the usage of the integrated member score to evaluate a member as well as to incentivize the member to participate in electronic peer access in a meaningful manner that generates quality content.

### System Overview

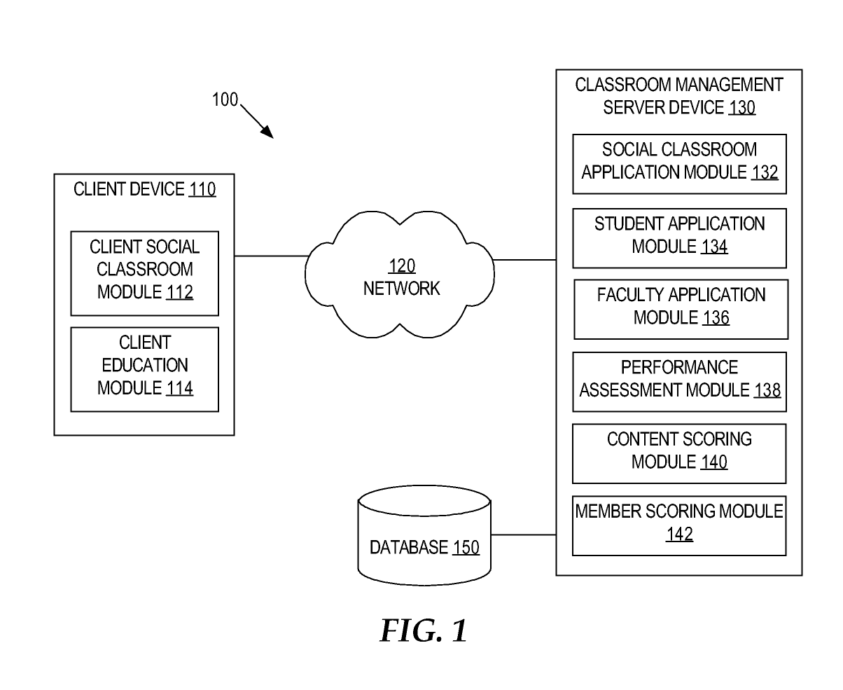

FIG. 1 is a block diagram of a system 100 for integrated social classroom and performance scoring, according to an embodiment. System 100 includes a client device 110, a classroom management server device 130, a network 120, and a database 150. Each of these components of the system 100 shall be described in greater detail hereafter. In one embodiment, one or more components of system 100 communicate via one or more Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication.

### Client Device

Client device 110 generally represents a device used by a member of an educational network, such as a student and/or a faculty member. Although one client device 110 is shown in system 100, system 100 may support a plurality of client devices 110. That is, each user can have multiple client devices, and the system architecture may support any number of users. Client device 110 is communicatively coupled to network 120, which may be implemented by one or more local area networks, the Internet, or any other computer networks. The elements of FIG. 1 may also communicate via direct communications links, wireless or wired, that are not depicted in FIG. 1 for purposes of explanation. Client device 110 is configured to communicate with at least classroom management server device 130 over network 120. Client device 110 may be implemented by any type of computing device, including but not limited to workstations, personal computers, laptop computers, personal digital assistants (PDAs), tablet devices, mobile devices such as smart phones, and any other computing devices.

In the illustrated embodiment, client device 110 is configured to execute client social classroom module 112 and client education module 114. Client social classroom module 112 and client education module 114 may be part of the same software application or different software applications, including web applications and/or mobile applications.

Client social classroom module 112 is configured to provide a social classroom interface that facilitates electronic peer access by a member of the educational network. For example, client social classroom module 112 may display social content associated with a group corresponding to one or more courses the member is enrolled in. The social content is generated by members of the group corresponding to the course. The social classroom interface may further include course information that is integrated with social content for the course.

In one embodiment, client social classroom module 112 is further configured to provide an interface that allows a member to submit content items to a group. In one embodiment, the submitted content item is a response to a content item submitted by another member. The social classroom interface may be displayed in a web browser, a web application, a mobile application, and/or any other application. In one embodiment, client social classroom module 112 obtains social content for display from social classroom application module 132 and transmits social content generated by a user of client device 110 to social classroom application module 132.

Client education module 114 is configured to perform client-side educational functions. Client education module 114 facilitates the performance of educational tasks by a member, such as a student or a faculty member. Client education module 114 may handle different types of members. For example, client education module 114 may determine whether a member is a student or faculty member and provide the appropriate client-side educational functions based on the determination. Alternatively, a different version of client education module 114 is tailored to one or more different types of members, such as students or faculty members.

When the user is a student, client education module 114 may present at least a portion of a learning activity to the user on client device 110. For example, client education module 114 may display educational media on client device 110, such as text, audio and/or video. Client education module 114 may further display one or more interactive learning activities, such as a live conference, or another interactive learning activity. In one embodiment, client education module 114 displays one or more interactive performance assessments, such as an assignment, a quiz, a test, or another interactive performance assessment. An interactive performance assessment is any type of interactive learning activity that can be performed on a computing device. In one embodiment, performance assessment module 138 automatically assesses an interactive performance assessment and stores the assessment data. The stored assessment data may be used to generate a performance metric and an integrated score for the user, which shall be described in greater detail hereafter. The educational media, interactive performance assessments, and/or interactive learning activities may be displayed in a web browser, a web application, a mobile application, and/or any other application. In one embodiment, client education module 114 communicates with student application module 134 and/or performance assessment module 138 in a client-server relationship.

When the user is a faculty member, client education module 114 may provide an instructor interface that facilitates instructor tasks with respect to a course. For example, client education module 114 may present one or more interfaces that facilitate communication with a group of students, communication with an individual student, student grading, generating assignments, or designing other course material. In one embodiment, the client education module 114 provides an interface for entering non-interactive performance assessment results for one or more students, such as the assessment for one or more non-computerized assignments, quizzes, exams or projects. The instructor interface may be displayed in a web browser, a web application, a mobile application, and/or any other application. In one embodiment, client education module 114 communicates with faculty application module 136 in a client-server relationship.

### Classroom Management Server Device

Classroom management server device 130 generally represents a server device configured to perform online classroom management functions. Classroom management server device 130 includes social classroom application module 132, student application module 134, faculty application module 136, performance assessment module 138, content scoring module 140, and member scoring module 142, each of which shall be described in greater detail hereafter. Although one classroom management server device 130 is shown in system 100, system 100 may include a plurality of classroom management server devices 130. For example, classroom management server device 130 may be provided as a distributed system or may be implemented in one or more cloud computing devices. Furthermore, although social classroom application module 132, student application module 134, faculty application module 136, performance assessment module 138, content scoring module 140, and member scoring module 142 are illustrated as modules of one classroom management server device 130, one or more of the aforementioned modules may be implemented on separate classroom management server devices 130 in communication with each other, such as via network 120.

### Social Classroom Application Module

Social classroom application module 132 manages an educational network. In one embodiment, the educational network corresponds to an educational institution. Members may include current students of the educational institution, alumni of the educational institution, and/or faculty members of the educational institution. In one embodiment, groups within the educational network are managed by social classroom application module 132. As used herein, the term “group” refers to a logical entity. A group may comprise zero or more members of the educational network. For example, social classroom application module 132 may manage groups within the educational network for groups of members that are associated with:
a particular course offering;
any current course offering of a particular course;
an area of study, such as a major or a minor;
an area of interest;
an extracurricular activity; and/or
a demographic group.

In one embodiment, social classroom application module 132 automatically provisions membership in groups within the educational network based on the activity of members of the educational network. For example, social classroom application module 132 may create a group for a new course, and may automatically add and/or remove members from the group based on the registration of members in one or more course offerings of the course.

Social classroom application module 132 may also accept, store, maintain and curate social content generated by members of the educational network, which shall be described in greater detail hereafter. The submitting and/or viewing of social content may be restricted based on membership in one or more groups. In one embodiment, social classroom application module 132 processes content items, generates the appropriate metadata, and stores the content items and metadata in database 150. In one embodiment, social classroom application module 132 interacts with client social classroom module 112 of client device 110 over network 120 to allow members to view and submit social content.

### Social Content

Social content includes content items generated and submitted by members of the educational network. Examples of social content include questions asked by members, answers provided by members, practice question-answer pairs created by members, discussions regarding learning activities, and other social participation submitted by members. Social content may also include submissions of external references, such as links to videos, articles, and other web resources. In one embodiment, social content includes links to content that is external to course material, but accessible through classroom management server device 130.

A member of the educational network may submit social content to a group to which the member belongs, such as a group associated with a course. In one embodiment, courses are divided into sections, and a content item is associated with a particular section of a course. In one embodiment, a particular section is made available to members registered in a particular course offering when the schedule of the particular course offering indicates that the particular ordered section is reached. For example, assume that a course is divided into ordered weekly sections. During Week 1 of the particular course offering, a registered user in the course offering may only have access to social content or submit content items associated with Week 1. On the other hand, at Week 5 of the particular course offering, the same user can able to access social content or submit content items associated with any of Weeks 1, 2, 3, 4, and 5 of the course.

Social classroom application module 132 may generate content metadata to track content items in the educational network. In one embodiment, social classroom application module 132 stores content items and their associated metadata in database 150. The content metadata may include data such as, but not limited to:
a submitting member;
an associated course;
an associated section of the associated course;
time/date of creation;
a number of viewers;
viewer identities;
viewer interactions with the content item;
specific time/date of viewed.

### Student Application Module

Student application module 134 manages course information and facilitates learning activities for members of the educational network that are students. A student is a member of the educational network that is registered in one or more course offerings associated with the educational network. In one embodiment, student application module 134 interacts with client education module 114 of client device 110 over network 120. Student application module 134 may provide server-side educational functions, such as sending and/or receiving learning activity data, educational media, and interactive learning activity data. For example, student application module 134 may provide data corresponding to an interactive learning activity for display on client device 110, and may receive data from client education module 114 indicating that the learning activity has been completed by the member using client device 110.

### Faculty Application Module

Faculty application module 136 manages course information and facilitates instructor activities for members of the educational network that are faculty members. A faculty member is a member of the educational network who has a teaching and/or administrative role for one or more course offerings associated with the educational network. Examples of faculty members include professors, lecturers, teaching assistants, and may include paid, unpaid, and/or guest faculty members. The same member may be a student with respect to a group associated with a first course and a faculty member with respect to a group associated with a second course. In one embodiment, faculty members for a course may include one or more expert members that have been identified based on an integrated member score. Expert members shall be described in greater detail hereafter.

In one embodiment, faculty application module 136 interacts with client education module 114 of client device 110 over network 120. Faculty application module 136 may provide server-side management functions corresponding to a course, such as managing communications between faculty members and students as well as sending, receiving and/or storing course management data such as grading data, assignment data, or other course material.

### Performance Assessment Module

Performance assessment module 138 assesses performance of one or more members of an educational network, including students and faculty members. For example, performance assessment module 138 may perform an assessment of a student based on one or more assignments, quizzes, or other learning activities performed by the student. Performance assessment module 138 may perform an assessment of a faculty member based on direct assessment of the faculty member's performance and/or assessment of the performance of students of the faculty member. Performance assessment, including student performance and faculty member performance, shall be described in greater detail hereafter.

Performance assessment module 138 may provide server-side assessment functions, such as sending and/or receiving interactive performance assessment data to client device 110. For example, performance assessment module 138 may provide data corresponding to an interactive performance assessment for display to a member on client device 110, receive completion data from client education module 114 regarding the member's completion of the interactive performance data, automatically assess the completion data to generate a performance assessment score, and store the performance assessment score. In one embodiment, the performance assessments are computer-based assessments. A member of the educational network may complete one or more computer-based assessments on client device 110 via client education module 114.

Performance assessment module 138 stores assessment data in a database, such as in database 150. The assessment data may be used by other components of classroom management server device 130, such as member scoring module 142. In one embodiment, the assessment data for one or more performance assessments is used to generate a performance metric for a member of the educational network, which is used to generate an integrated member score for the member.

### Content Scoring Module

Content scoring module 140 scores content items submitted by members of the educational network. In one embodiment, content scoring module 140 generates scores for content items based on one or more scoring metrics. According to one embodiment, content scoring is a way to measure the quality of a content item. The quality of a content item may be defined and calculated based on one or more factors, and the definition and/or calculation may differ between systems, within systems, between different course classifications, between different content item classifications, or based on any other classification. For example, the quality of a content item may be based on an affect of viewing the content item on viewer performance on a related task, the relevance of the content item, a level and/or type of interaction between members and the content item, member rating on the content item, or other factors Content scoring module 140 may use content metadata associated with a content item to score the content item and generate content score data that represents the score for the content item. Content scoring shall be described in greater detail hereafter.

Content scoring module 140 stores content score data in a database, such as database 150. The content score data may be used by other components of classroom management server device 130, such as member scoring module 142. In one embodiment, the content score data for one or more content items submitted by a member is used to generate a contribution metric for a member of the educational network, which is used to generate an integrated member score for the member.

### Member Scoring Module

Member scoring module 142 generates an integrated member score for a student in the educational network. The integrated member score generated by member scoring module 142 is based on a contribution component and a performance component. Member scoring module 142 may score both students and faculty members of the educational network.

### Integrated Member Score

In one embodiment, the integrated member score is generated based on a member contribution metric and a member performance metric for a member of the educational network. The member contribution metric, which shall be described in greater detail hereafter, is determined for a member based on a set of content item scores for content items generated by the member. The member performance metric, which shall be described in greater detail hereafter, is determined for a member based on at least one performance assessment of the member.

### Member Contribution Metric

A member contribution metric is any metric that quantifies the contribution of a member to an educational network. For example, a member contribution metric may be generated based on content item scores that are calculated for content items generated by the member. As noted above, the integrated member score generated by member scoring module 142 is determined based at least in part on a member contribution metric.

In one embodiment, the member contribution metric is determined based on a set of content item scores for content items generated by the member, such as content item scores generated by content scoring module 140. The content item score shall be described in greater detail hereafter.

In one embodiment, when member scoring module 142 determines a member contribution metric for a member, content item scores are either calculated or recalculated, by content scoring module 140, for one or more content items generated by the member. Alternatively and/or in addition, one or more content item scores are obtained from storage, such as from database 150. In one embodiment, an individual determination is made whether to obtain a particular content item score from storage or to calculate/recalculate the particular content item score. The determination may be based on the age of any existing content item score for the item, an amount of viewing activity since the last calculation of the content item score, an amount of time elapsed since the last calculation of the content item score, or any other relevant factor.

In one embodiment, when scoring a faculty member, member scoring module 142 further determines a responsiveness of the faculty member with respect to content items submitted by students that include questions directed at a faculty member. Because different course offerings of the same course may be associated with the same group, multiple faculty members may have the chance to respond to the question. For a faculty member, member scoring module 142 may determine the faculty member's member contribution metric based further on the responsiveness of the faculty member.

When member scoring module 142 determines a member contribution metric for a member, individual content item scores may be weighted. For example, content item scores may be weighted based on metadata associated with the content item (e.g. the age of the content item, a number of viewers, viewer interactions, time since last access, etc.). Content item scores may also be weighed based on factors pertaining to the member, such as whether the content item is submitted to a group that corresponds to a major of the member. In one embodiment, the content item score is weighted based on factors pertaining to the member, while content metadata that is not member-specific is already taken into account in the generation of the content item score. For example, for a student, a higher weight may be given to submitted content items that correspond to current courses the student is enrolled in and/or submitted content items that correspond to a major of the student. For a faculty member, a higher weight may be given to submitted content items that correspond to current courses the faculty member is teaching and/or courses that fall within the faculty member's area of study.

### Content Item Score

In one embodiment, a content item score is generated for content items submitted to the educational network. A content item score is any score that quantifies the quality of a particular content item. The content item score of a particular content item may change over time. For example, if viewer interaction is a component of the content item score, then increased viewer interaction over time will affect the content item score of the content item.

Content scoring module 140 may generate a content item score for one or more content items periodically, or when a scoring event occurs. A scoring event is any event that can trigger the calculation or recalculation of a content item score for one or more content items. Example scoring events include milestones within a course offering associated with the content item such as a midterm or the end of a course, interactions and accesses of the content item by other members, or a calculation that requires a content item score for a particular item. For example, a scoring event may occur when member scoring module 142 determines a member contribution metric, causing the calculation or recalculation of one or more content item scores for content item generated by a particular member. Alternatively and/or in addition, member scoring module 142 may obtain one or more content item scores from storage, such as from database 150.

Content scoring module 140 may determine a content item score based on one or more content scoring metrics, including but not limited to the content scoring metrics described in greater detail hereafter. Content scoring module 140 may use any combination of content scoring metrics to generate a score for a content item, and may use different combinations of scoring metrics in different situations. Furthermore, content scoring module 140 may periodically reevaluate one or more scores for a particular content item. For example, the relevance of a particular content item may change over time, and this change may affect the relevance metric of the particular content item, and thereby affect the score of the particular content item.

Examples of scoring metrics include, without limitation:
viewer outcome metrics;
non-viewer outcome metrics;
relevance metrics;
affinity metrics;
rating metrics.

This list is a non-limiting set of example metrics that may be calculated for the purpose of scoring a content item. These metrics are each described in greater detail hereafter.

### Scoring Content Based on Outcomes

In one embodiment, a content item score is based on a viewer outcome metric and a non-viewer outcome metric. A “viewer outcome metric” is any metric that quantifies the performance of members of an educational network (or members who belong to a particular group within the educational network) who have viewed a particular content item. A “non-viewer outcome metric” is any metric that quantifies the performance of members of the educational network (or members who belong to the particular group within the educational network) who have not viewed the particular content item. The viewer outcome metric and the non-viewer outcome metric may be based performance assessment scores of viewers and non-viewers. The performance assessment scores are for the same set of performance assessment/s. If viewers of a content item perform significantly better on the same performance assessment/s than non-viewers, then the viewer outcome metric for the content item should be higher than the non-viewer outcome metric. The combination of a high viewer outcome metric and a low non-viewer outcome metric increases the content item score of the content item.

For example, if a member submits a content item for a section, Week 2, of a course, a viewer outcome metric and a non-viewer outcome metric may be calculated for the content item based on performance of members of the educational network on an assignment and/or quiz for Week 2. More specifically, content scoring module 140 may calculate a viewer outcome metric based on the performance of members who viewed the content item, and content scoring module 140 may calculate a non-viewer outcome metric based on the performance of one or more members who did not view the content item. In one embodiment, content scoring module 140 calculates outcome metrics based on existing assessment data generated by performance assessment module 138. For example, performance assessment module 138 may assess the assignment and/or quiz for Week 2. In one embodiment, performance assessment module 138 stores the assessment data for individual members in database 150, and content scoring module 140 accesses the stored assessment data in order to score the content item.

In one embodiment, viewer outcome metrics and non-viewer outcome metrics are determined for members of the educational network who belong to a particular group. For example, the viewer outcome metric and the non-viewer outcome metric may be determined for members who are students in a particular course, and who belong to a group corresponding to a the particular course. In one embodiment, viewer outcome metric and the non-viewer outcome metric may be based on the performance of people that are no longer members of the group (“historical members” of the group). Content scoring module 140 may weigh the performance of current members of the group more heavily than the performance of historical members of the group. Alternatively and/or in addition, content scoring module 140 may weigh the viewer outcome metric and the non-viewer outcome metric.

### Scoring Content Based on Relevance

In one embodiment, the score of a content item is a function of relevance. A “relevance metric” is any metric that quantifies a level of relevance that the content item has with respect to the educational network (or a particular group within the educational network). For example, when the group is associated with a particular course, the relevance metric may quantify the relevance between a content item and the particular course or a particular section within the particular course. Various relevance metrics may be used by content scoring module 140, and one or more relevance metrics may be used to score a particular content item. For example, a relevance metric may be based on one or more time factors, such as the age of a content item, the amount of recent interaction with the content item by members, or other time factors. One or more other relevance metrics may be used to score one or more content items, either alone or in conjunction with any combination of the scoring metrics described herein.

### Scoring Content Based on Affinity

In one embodiment, the score of a content item is a function of affinity. As used herein, the term “affinity” refers to a high level of interaction between members of the educational network (or members who belong to a particular group within the educational network) and the content item. Thus, an “affinity metric” is any metric that quantifies a level of interaction with the content item. Various affinity metrics may be used by content scoring module 140, and one or more affinity metrics may be used to score a particular content item. For example, an affinity metric may be based on an amount of time that a member interacts with the content item when the content item is displayed to the member. When the content item includes a link, the affinity metric may be based on whether members follow the link when the content item is displayed. One or more other affinity metrics may be used to score one or more content items, either alone or in conjunction with any combination of the scoring metrics described herein.

### Scoring Content Based on Rating

In one embodiment, the score of a content item is a function of member rating. A “rating metric” is any metric that quantifies member rating with respect to the content item. Various rating metrics may be used by content scoring module 140, and one or more rating metrics may be used to score a particular content item. In one embodiment, social classroom module 112 allows members of the educational network (or members who belong to a particular group within the educational network) to rate content items. For example, members can rate content items according to a numerical rating (e.g. 5 stars), a binary rating (e.g. thumbs up, thumbs down), or in accordance with any other rating scheme. Furthermore, members can rate content items according to different categories, such as usefulness, entertainment value, and other categories. Various rating metrics may be defined based on such content item ratings. For example, a rating metric may be a function of all the ratings received for a content item. In one embodiment, a rating metric is a function of weighted ratings that are weighted based on factors such as recentness of the rating, a reputation rating of the rating member, a participation rating of the rating member, or other such factors. One or more other rating metrics may be used to score one or more content items, either alone or in conjunction with any combination of the scoring metrics described herein. rate

### Example Process for Scoring a Content Item

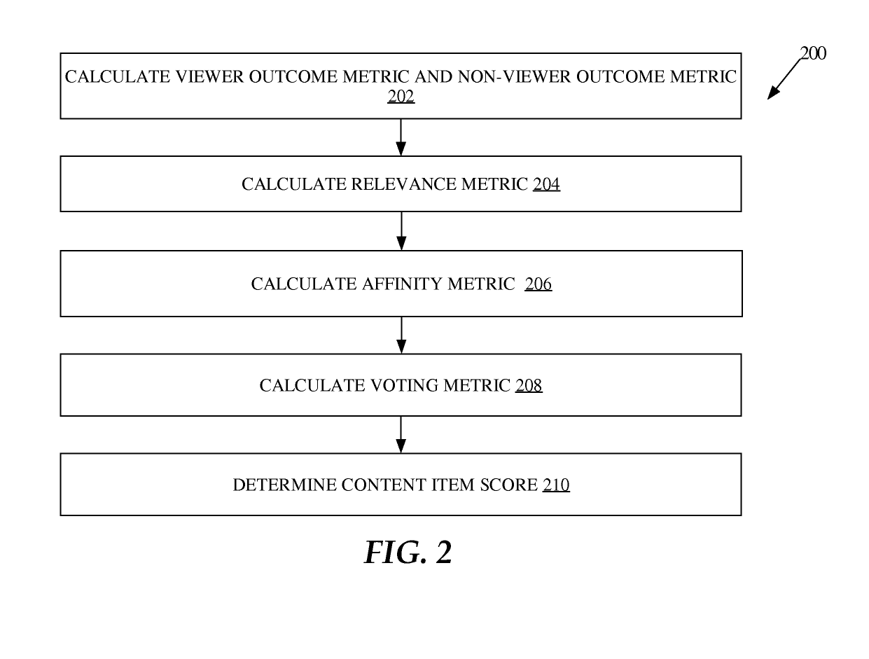

FIG. 2 is a flow diagram that depicts an embodiment of a process for scoring a content item. Process 200 is performed by one or more computing devices and/or processes thereof, such as computing device 400. In one embodiment, a content scoring module 140 of a classroom management server device 130 performs process 200.

At block 202, content scoring module 140 calculates a viewer outcome metric and a non-viewer outcome metric. At block 204, content scoring module 140 calculates a relevance metric. At block 206, content scoring module 140 calculates an affinity metric. At block 208, content scoring module 140 calculates a rating metric. At block 210, a score is determined for the content item based on one or more of the calculated viewer outcome metric, non-viewer outcome metric, relevance metric, affinity metric, and rating metric.

In one embodiment, one or more additional metrics are calculated, which may include one or more additional outcome metrics, relevance metrics, affinity metrics, and/or rating metrics. Likewise, in one embodiment, one or more of the metrics described in process 200 may be omitted from calculation and/or determination of the score for one or more content items. The score for different content items may be determined based on a different set of metrics and/or a different calculation based on the metrics. For example, different types of content items may be evaluated differently, such as member-submitted questions and answers as compared to member-submitted external references. Furthermore, scores for content items may be determined for different purposes, and a different set of metrics and/or a different calculation based on the metrics. For example, the exact determination of a content item score may differ for the purposes of selecting top content for display, selecting customized content for display to a particular member, identifying quality content to persist, or for other purposes.

### Member Performance Metric

A member performance metric is any metric that quantifies the performance of a member with respect to one or more performance assessments. In one embodiment, a member performance metric is based on a set of one or more performance assessment scores associated with the member.

When the member is a student, the member performance metric may be based on final exams for every course the member has completed. Other member performance assessments may be used, such as performance assessment scores for other quizzes, exams, projects, assignments, or any other performance assessment, including any combination thereof.

When the member is a faculty member, the member performance metric may be based on one or more performance assessment scores for the students of the faculty member in one or more courses, including any combination of final exams, quizzes, other exams, projects, assignments, or other performance assessments. As used herein, an evaluation of the performance of the students of a faculty member is itself considered a performance assessment of a faculty member.

When a particular group of the educational network corresponds to multiple course offerings of the same course that are taught by different faculty members, content items submitted to the group by a particular faculty member may be viewed by students of other faculty members because the students of the different course offerings may belong to the same group. This illustrates an important difference between the member contribution metric and the member performance metric: the member contribution metric of the faculty member may be based on a viewer outcome metric and non-viewer outcome metric of students in the particular group, which may include students from other course offerings not directly instructed by the faculty member; the member performance metric is based on the performance of the faculty member's students, whether the faculty member's students have viewed one or more content items submitted to the group by the faculty member.

In one embodiment, member scoring module 142 determines a member performance metric in the course of determining the integrated member score for a member. The member performance metric is determined based on a set of performance assessment scores associated with the member, such as performance assessment scores generated by and/or managed by performance assessment module 138. In one embodiment, member scoring module 142 obtains one or more performance assessment scores for the member from database 150.

When member scoring module 142 determines a member performance metric for a member, individual performance assessment scores may be weighted. For example, performance assessment scores may be weighted based on one or more characteristics of a student. For example, when determining a performance assessment metric for a faculty member, a special needs student or an honor student may be weighted differently. Performance assessment scores may also be weighed based on other factors, such as the age of the performance assessment score. For example, historical performance assessments for past courses or course offerings may be weighted less than current performance assessment scores for current courses or current course offerings. In one embodiment, performance assessments corresponding to a major of the student or a specialty of the faculty member are weighted more than other performance assessments that do not correspond to the major or specialty.

### Example Process for Evaluating a Member

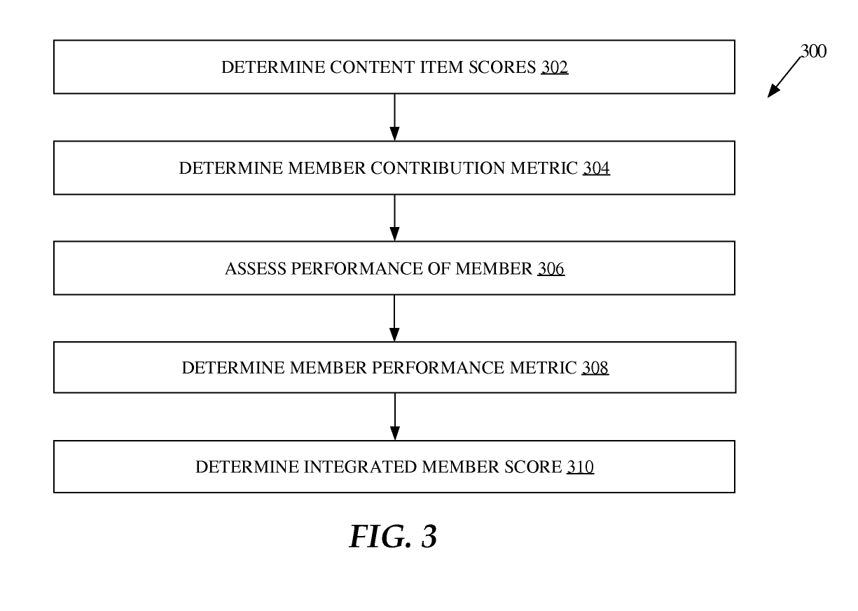

FIG. 3 is a flow diagram that depicts an embodiment of a process for generating an integrated member score. Process 300 is performed by one or more computing devices and/or processes thereof, such as computing device 400. For example, one or more classroom management server devices 130 may perform process 300.

At block 302, content scoring module 140 determines content item scores for content items submitted by the member of the educational network. At block 304, member scoring module 142 determines a member contribution metric for the member. At block 306, performance assessment module 138 assesses the performance of the member. At block 308, member scoring module 142 determines a member performance metric for the member. At block 310, member scoring module 142 determines an integrated member score for the member.

In one embodiment, member scoring module 142 determines one or more additional metrics that contribute to the integrated member score. Likewise, in one embodiment, member scoring module 142 may omit one or more of the metrics described in process 200.

### Usage of Integrated Member Score for Faculty Members

In one embodiment, classroom management server device 130 is configured to provide one or more benefits for faculty members based on their integrated member score. Classroom management server device 130 may provide such benefits based on an objective measure, such as based on a threshold integrated member score. Alternatively and/or in addition, classroom management server device 130 may provide one or more benefits based on a subjective measure, such as a ranking or percentile relative to other faculty members. A subject measure may be relative to other faculty members of a course, an area of study, or the entire educational network. Faculty members may qualify for one or more benefits based on their integrated member score. Benefits may include increased priority in course selection, increased priority in course scheduling, recognition in an online resource of the educational network (e.g. a university website), compensation levels, or other benefits that are related a faculty member's role in an educational institution.

In one embodiment, multiple integrated member scores may be calculated, and different integrated member scores may be used to evaluate qualification for different benefits. For example, when an instructor teaches courses in different departments, such as a math department and an engineering department, a first integrated member score may be calculated to determine whether the faculty member qualifies for a benefit determined by the math department, and a second integrated member score may be calculated to determine whether the faculty member qualifies for a benefit determined by the engineering department. For example, the first integrated score may be calculated using math as an area of specialty, and the second integrated score may be calculated using engineering as an area of specialty.

### Usage of Integrated Member Score for Students

In one embodiment, classroom management server device 130 is configured to provide one or more benefits for students based on their integrated member score. Classroom management server device 130 may provide such benefits based on an objective measure, such as based on a threshold integrated member score. Alternatively and/or in addition, classroom management server device 130 may provide one or more benefits based on a subjective measure, such as a ranking or percentile relative to other students. A subject measure may be relative to other students in a course offering, a course, an area of study, another group within the educational network, or the entire educational network. Students may qualify for one or more benefits based on their integrated member score. Benefits may include increased priority in course selection, recognition in an online resource of the educational network (e.g. a university website), scholarships, educational assistance, career counseling, recognition as a top student to potential employers, recognition of the student as a domain expert in the subject, recognition of the student as having leadership/engagement qualities, and promoting the student to third party employers, recognition in or other benefits that are related to a student's role in an educational institution.

In one embodiment, multiple integrated member scores may be calculated, and different integrated member scores may be used to evaluate qualification for different benefits. For example, when a student is enrolled in courses from different departments, such as a math department and an engineering department, a first integrated member score may be calculated to determine whether the student qualifies for a benefit determined by the math department, and a second integrated member score may be calculated to determine whether the student qualifies for a benefit determined by the engineering department.

### Expert Member

In one embodiment, an integrated member score is used to retain a student in a group corresponding to a course, even after the completion of the course by the student. For example, a student may belong to a group based on his enrollment in a particular course offering. Based on his integrated member score, the student may be invited to remain in the group as an expert member. As an expert member, the student is able to continue to participate in the social dialog for future course offerings of the same course.

The expert member position may be voluntary or compensated. In one embodiment, the compensation comprises educational credits, recognition in an online resource of the educational network, a formal teaching assistant role, monetary combination, or any combination thereof. In one embodiment, the expert member is treated as a faculty member position, such as an official teaching assistant. In this manner, the integrated member score of the prior student is used to make the faculty member position offer. Alternatively, the expert member may be treated as an additional member type other than student or faculty member.

### IMPLEMENTATION EXAMPLES

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

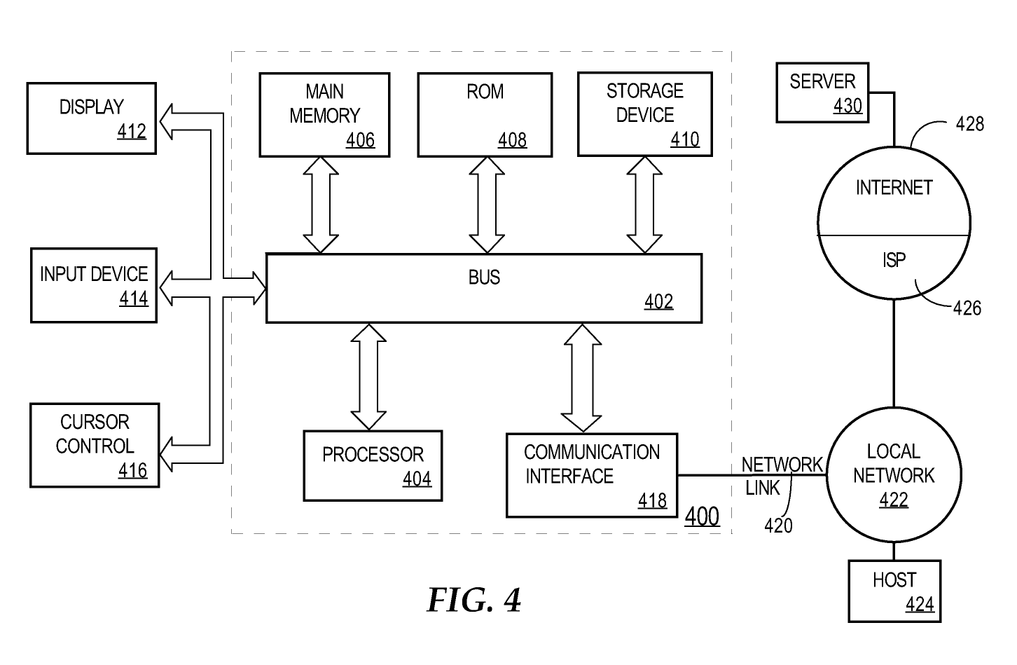

For example, FIG. 4 is a block diagram that depicts a computer system 400 upon which an embodiment may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
displaying one or more content items submitted by a member of an educational network to one or more other members of the educational network;
determining a set of content item scores comprising a content item score for each of at least a subset of the one or more content items submitted by the member;
determining a member contribution metric for the member based on the set of content item scores;
determining a member performance metric for the member based on at least one performance assessment of the member with respect to one or more courses;
determining an integrated member score for the member based on the member contribution metric and the member performance metric;
wherein the method is performed by one or more computing devices.

2. The method of claim 1,
wherein the member is a student currently registered in a current course of the one or more courses,
wherein the member performance metric is based on at least one performance assessment of the member with respect to the current course.

3. The method of claim 1,
wherein the member is a faculty member of a current course of the one or more courses,
wherein the at least one performance assessment of the faculty member with respect to the current course is based on performance assessments of students of the faculty member in the current course.

4. The method of claim 1, wherein the at least one performance assessment comprises at least one performance assessment of the member with respect to one or more prior courses.

5. The method of claim 1, wherein determining the set of content item scores comprises scoring a particular content item submitted by the member by:
calculating a viewer outcome metric based on a performance assessment of one or more members that have viewed the particular content item;
calculating a non-viewer outcome metric based on a performance assessment of one or more members that have not viewed the particular content item;
determining a content item score for the particular content item based at least in part on the viewer outcome metric and the non-viewer outcome metric.

6. The method of claim 1, wherein determining the set of content item scores comprises scoring a particular content item submitted by the member by:
determining a content relevance metric for the particular content item that quantifies a level of relevance that the particular content item has with respect to the one or more courses;
determining a content item score for the particular content item based at least in part on the content relevance metric for the particular content item.

7. The method of claim 1, wherein determining the set of content item scores comprises scoring a particular content item submitted by the member by:
determining an affinity metric for the particular content item that quantifies a level of interaction between members of the extended group and the particular content item;
determining a content item score for the particular content item based at least in part on the affinity metric for the particular content item.

8. The method of claim 1, wherein determining the set of content item scores comprises scoring a particular content item submitted by the member by:
determining a rating metric for the particular content item based on rating by members of the extended group;
determining a content item score for the particular content item based at least in part on the rating metric for the particular content item.

9. The method of claim 1, further comprising:
determining that the member meets a qualification criteria based on the integrated member score for the member.

10. The method of claim 9, further comprising:
after determining that the member meets the qualification criteria based on the integrated member score for the member, automatically providing the member priority in a course selection system associated with the educational network.

11. The method of claim 9, further comprising:
after determining that the member meets the qualification criteria based on the integrated member score for the member, displaying a recognition indicator in association with an online presence of the member.

12. A non-transitory computer-readable medium storing instructions which, when executed by one or more processors, cause the one or more processors to perform:
displaying one or more content items submitted by a member of an educational network to one or more other members of the educational network;
determining a set of content item scores comprising a content item score for each of at least a subset of the one or more content items submitted by the member;
determining a member contribution metric for the member based on the set of content item scores;
determining a member performance metric for the member based on at least one performance assessment of the member with respect to one or more courses;
determining an integrated member score for the member based on the member contribution metric and the member performance metric;
wherein the method is performed by one or more computing devices.

13. The non-transitory computer-readable medium of claim 12,
wherein the member is a student currently registered in a current course of the one or more courses,
wherein the member performance metric is based on at least one performance assessment of the member with respect to the current course.

14. The non-transitory computer-readable medium of claim 12,
wherein the member is a faculty member of a current course of the one or more courses,
wherein the at least one performance assessment of the faculty member with respect to the current course is based on performance assessments of students of the faculty member in the current course.

15. The non-transitory computer-readable medium of claim 12, wherein the at least one performance assessment comprises at least one performance assessment of the member with respect to one or more prior courses.

16. The non-transitory computer-readable medium of claim 12, wherein determining the set of content item scores comprises scoring a particular content item submitted by the member by:
calculating a viewer outcome metric based on a performance assessment of one or more members that have viewed the particular content item;
calculating a non-viewer outcome metric based on a performance assessment of one or more members that have not viewed the particular content item;
determining a content item score for the particular content item based at least in part on the viewer outcome metric and the non-viewer outcome metric.

17. The non-transitory computer-readable medium of claim 12, wherein determining the set of content item scores comprises scoring a particular content item submitted by the member by:
determining a content relevance metric for the particular content item that quantifies a level of relevance that the particular content item has with respect to the one or more courses;
determining a content item score for the particular content item based at least in part on the content relevance metric for the particular content item.

18. The non-transitory computer-readable medium of claim 12, wherein determining the set of content item scores comprises scoring a particular content item submitted by the member by:
determining an affinity metric for the particular content item that quantifies a level of interaction between members of the extended group and the particular content item;
determining a content item score for the particular content item based at least in part on the affinity metric for the particular content item.

19. The non-transitory computer-readable medium of claim 12, wherein determining the set of content item scores comprises scoring a particular content item submitted by the member by:
determining a rating metric for the particular content item based on rating by members of the extended group;
determining a content item score for the particular content item based at least in part on the rating metric for the particular content item.

20. The non-transitory computer-readable medium of claim 12, wherein the instructions, when executed by the one or more processors, further cause the one or more processors to perform:
determining that the member meets a qualification criteria based on the integrated member score for the member.

21. The non-transitory computer-readable medium of claim 20, wherein the instructions, when executed by the one or more processors, further cause the one or more processors to perform:
after determining that the member meets the qualification criteria based on the integrated member score for the member, automatically providing the member priority in a course selection system associated with the educational network.

22. The non-transitory computer-readable medium of claim 20, wherein the instructions, when executed by the one or more processors, further cause the one or more processors to perform:
after determining that the member meets the qualification criteria based on the integrated member score for the member, displaying a recognition indicator in association with an online presence of the member.
